(19) United States
(12) Patent Application Publication
(10) Pub. No.: US 2007/0198818 A1
(43) Pub. Date: Aug. 23, 2007

(54) Configuration-controlled user interface

(75) Inventors: Bernd Graw, Paderborn (DE); Joachim Seibert, Brilon (DE)

Correspondence Address: HARNESS, DICKEY & PIERCE, P.L.C., P.O. BOX 828, BLOOMFIELD HILLS, MI, 48303, US

(73) Assignee: Wincor Nixdorf GmbH & Co., Paderborn (DE)

(21) Appl. No.: 10/587,739

(22) PCT Filed: Jan. 25, 2005
(86) PCT No.: PCT/DE05/00097

§ 371 Date: Jul. 27, 2006

(30) Foreign Application Priority Data
Jan. 30, 2004 (DE) 10 2004 004 993.9

(51) Int. Cl. G06F 15/177

(52) U.S. Cl. 713/1

(57) ABSTRACT

An operation of controlling the interactions which are offered by a user interface of a device on the basis of service features which are available for the device, indicators being determined by the combination of service features, each interaction being assigned an indicator and a limiting value, the interaction being offered if the indicator complies with the limiting value.

The invention relates to the operation of controlling the user interaction, i.e. the user interface, of self-service devices, in particular.

Patent specification U.S. Pat. No. 5,432,941 describes a method and a system for dynamically configuring software systems which use configuration groups. However, these and other solutions run at the time of installation and are inadequate for the problem solved by the invention.

The user interface of self-service devices should be as simple as possible and should be capable of being immediately understood. For self-service devices including cash machines, in particular, this means that the customers receive the desired information quickly and can carry out the desired transaction.

In this case, the possibility of dead ends occurring in the control operation should be avoided, in particular. Such a dead end exists, for example, when options are offered in a menu structure but an error message, for example “function not available”, “function not allowed”, “device out of service” or the like, appears for said options only after they have been activated. An effect which is similarly to be avoided involves the offer of submenus which do not contain a single function which can be activated.

These undesirable effects may be avoided by virtue of the programs which provide the user interfaces being individually programmed in such a manner that the configuration is respectively interrogated using branches in the program and these situations are avoided by the variants being programmed out. Although possible, this approach is very complicated, susceptible to errors and is difficult to document.

It is an object of the invention to provide an improved operation of controlling the user interaction which solves this problem in a simpler and clearer manner.

The invention involves providing the requisite configuration information and, listed in indicators, rendering the program flow dependent only on the indicators which have been determined in this manner.

In the drawings:

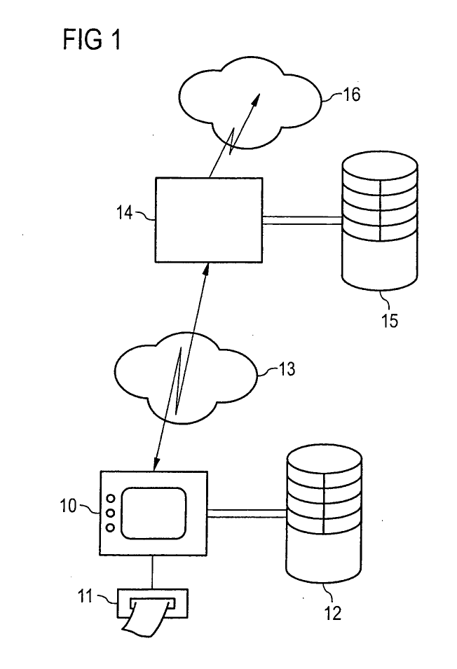

FIG. 1 shows one possible configuration of a development,

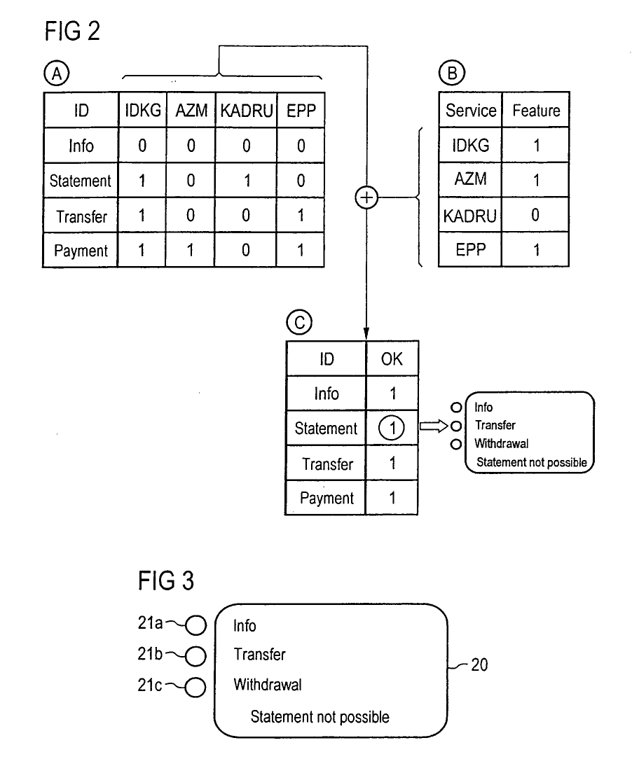

FIG. 2 shows determination of indicators using tables, and

FIG. 3 shows a resultant display.

FIG. 1 shows a client 10, for example a cash dispenser, which comprises peripherals such as, inter alia, a card reader 11. The devices which are available and active are entered in a table 12. The client 10 is connected, via a network connection 13, to a server 14 which, in turn, is connected to a bank network 16. The server 14 contains a database 15, the use of which will be described further below. In this configuration which already represents a development, the server 14 uses the configuration data which have been entered in the table 12 or database 15 to generate the output for the client 10. In this case, the configuration data which relate to the client 10 and are transmitted by the latter are preferably dynamically provided in the network version in the server, i.e. are frequently updated in an appropriate manner. However, a simple embodiment which does not presuppose a server and a network connection and in which the subsequent client 10 is a cash machine will first of all be described.

This cash machine generally contains a card reader which can read magnetic strip cards and chip cards and is denoted IDKG for short. A payment module AZM is also possible. Furthermore, the amount of money present therein is denoted AZVAL. A statement printer KADRU can also be installed. A PIN keypad EPP which is protected against manipulation is installed for the purpose of verifying authorization.

The following table now defines four transactions INFO, STATEMENT, TRANSFER and PAYMENT:

| | ID | | | | |
|---|---|---|---|---|---|
| | IDKG | AZM | AZVAL | KADRU | EPP |
| INFO | * | * | * | * | * |
| STATEMENT | 1 | * | * | 1 | * |
| TRANSFER | 1 | * | * | * | 1 |
| PAYMENT | 1 | 1 | 500 | * | 1 |

In this case, a star “*” represents any desired value. The transactions are then as follows:
INFO General information: no device necessary.
STATEMENT Printing a statement: card reader IDKG for the account number and statement printer KADRU are required.
TRANSFER Inputting a transfer: card reader IDKG and a PIN keypad EPP for authorization are required.
PAYMENT Paying an amount: only the statement printer is not required.

In this case, the devices and their characteristics, in abstract terms, represent service features which may be both numerical (AZVAL) and boolean. The symbols INFO, STATEMENT etc. in the first column represent indicators. A respective indicator is assigned to a combination of service features using the table.

In this case, the service feature is available if the corresponding device has been installed and is ready for operation. Therefore, it may be expedient to determine this service feature using two tables; in one table, the devices which have been installed in the respective device are listed independently of the operating state, and, in the second table, the operator or engineer may provide (online) or may not provide (offline) (installed) devices.

A customary database interrogation then provides the following table, for example:

| Device | Service feature |
|---|---|
| IDKG | 1 |
| AZM | 1 |
| AZVAL | 20000 |
| KADRU | 0 |
| EPP | 1 |

Combination with the above table reveals the availability of the service features:

| ID | Available |
|---|---|
| INFO | 1 |
| STATEMENT | 0 |
| TRANSFER | 1 |
| PAYMENT | 1 |

In this case, the indicators are represented in the form of boolean values with 0 or 1, thus resulting in a clear YES/NO statement. This operation is illustrated in FIG. 2. In this case, 1 is then simply the limiting value for which the service feature is deemed to be applicable.

In the simplest case, the indicators are each directly assigned to a soft key of a screen mask, thus signaling to the user that, of the four possible selections INFO, STATEMENT, TRANSFER and PAYMENT, only STATEMENT is not available; this could appear as shown in FIG. 3. The latter shows a screen 20 which has function keys (soft keys) 21a, 21b and 21c and in which the three available interactions were each assigned a soft key and an explanatory text was displayed for the interaction which was not available.

Formulae may also be used instead of tables; in the above case, this would be as follows for the last row, for example:
PAYMENT:=IDKG & AZM & (AZVAL>500) & EPP

The evaluation of such expressions is generally known from the field of interpreted programming languages.

In the above representation, the symbol “*” was used for “any desired”. As an alternative to this, the logic values may be entered as “0” and “1” and a value comparison may take place; a “0” then acts as “any desired”.

The invention exhibits its potential in one preferred development of a configuration, as shown in FIG. 1. Cash machines are nowadays operated as clients in a network having servers; the network is used not only to handle the pure banking transactions but also to prepare and define the user interface. The solution in which a HTML browser (whose HTML file is respectively provided by the server) is used to configure the user display is particularly widespread. In this case, the service features are transmitted from the client to the server; an existing maintenance component in the network is preferably used for this purpose. It goes without saying that the headers in the HTTP protocol may also be used for this purpose, as is proposed, for example, in RFC 2295 “Transparent Content Negotiation in HTTP; K. Holtman, A. Mutz; March 1998”. Another possibility is to set up a server-like service in the client, in the case of which the server can interrogate the configuration data. Alternatively or additionally, in the event of a change, the client itself can transmit the data to the server in the form of changed service features (“push” operation).

These then include service features which are determined in the server. These may be, for example, all banking circles to which there is an online connection.

To this end, use is made of a variant of the invention in which the values of the indicators can be interrogated in updated form by the software at any time. If an indicator is determined using a formula, this is the case anyway. If an indicator is determined using database table operations, an updating function which recreates the above table can be provided. Modern database systems make it possible to define even complex interrogations as “view” and then to automatically update them. In this case, the database structure must be configured in such a manner that the data additionally contain an indication of the terminal, i.e. the client, and the above tables are available as “view”, for example.

This results in the following sequence:

An indicator LOGIN which requires only the card reader is first of all defined. Reading the card transmits the card number to the server which uses the card number and, if appropriate, other details on the magnetic track or in the chip to determine the banking circle. The banking circle is then entered in the database (relative to the respective client device) and the indicators are reassessed.

In an amendment to the above table, the indicator TRANSFER is activated only for particular banking circles, for example. If there is more than one banking circle, a plurality of rows which differ only in the field for the banking circle are entered in the implementation (outlined) using relational databases.

In the same manner, the account number is used to discern the services to which the customer has access, and a corresponding table is updated. In the same way as the banking circles, these are then included in the conditions for the indicators, with the result that a menu entry for “transfer” is displayed only when not only is a PIN keypad present but transfers are also enabled for the customer.

It becomes clear from the example that the creation and maintenance of the software for the user interface are considerably simplified using the invention. The software no longer directly interrogates which functions are ready but instead uses indicators which, as a whole, are no longer dependent on the installation and the customer. According to the preferred variant, adaptation to the respective installation is effected using tables whose data model may also be predefined and standard. Only the different application-related contents of the tables determine the interactions which are offered.

1. In an operation of controlling the interactions which are offered by a user interface of a device on the basis of service features which are available for the device, the improvement wherein:
indicators are determined by the combination of service features,
each interaction is assigned an indicator and a limiting value, and
wherein the interaction is offered if the indicator complies with the limiting value.

2. The control operation as claimed in claim 1, wherein the service feature is in the form of a truth value indicating the availability of a service or in the form of a numerical value indicating the available capacity of a service.

3. The control operation as claimed in claim 2, wherein service features are assigned to indicators using expressions.

4. The control operation as claimed in claim 2, the indicator being a truth value and the indicators corresponding to Boolean expressions having arithmetic comparison operators for the services with a numerical value.

5. The control operation as claimed in claim 1, the indicators being determined using a table in which each indicator is assigned limiting values for the service features.

6. The control operation as claimed in claim 5, a special entry which is always applicable being provided for a service feature.

7. The control operation as claimed in claim 1, the device, as a client, being connected to a server which provides the client with services which depend on indicators, and a method for determining corresponding service features being prescribed and it being possible to use these service features to determine indicators.

8. The control operation as claimed in claim 7, wherein the services which are provided for the client by the server include the configuration of the user interface.

9. A method of controlling all of the interactions using a central server which dynamically manages the services and service features which are available in the client and, in addition, also allows the availability of its own operating means (DB, host connection etc.) to be included in the assessment.

10. The method as claimed in claim 9, the interactions offered and the indicators being determined in the server and service features being transmitted from the client to the server.
